(19) United States
(12) Patent Application Publication
(10) Pub. No.: US 2005/0197825 A1
(43) Pub. Date: Sep. 8, 2005

(54) Personal digital assistant with text scanner and language translator

(75) Inventors: William Ernest Hagerman, Naperville, IL (US); Herbert Wayne Halcomb, Naperville, IL (US)

Correspondence Address: Richard J. Minnich, Esq.;Fay, Sharpe, Fagan, Minnich & McKe, LLP, Seventh Floor, 1100 Superior Avenue, Cleveland, OH, 44114-2518, US

(73) Assignee: Lucent Technologies Inc.

(21) Appl. No.: 10/794,934

(22) Filed: Mar. 5, 2004

(51) Int. Cl. G06F 17/28

(52) U.S. Cl. 704/2

(57) ABSTRACT

A PDA (10) is provided that includes: an LCD touch screen (12) that supports a GUI through which a user selectively provides input to the PDA (10); a scanner (16) housed within the PDA (10), the scanner (16) selectively capturing an image by passing the scanner (16) over the image; an OCR object (30) which identifies characters of text within an image captured by the scanner (16), the OCR object (30) generating text in a first language; and, a language translation object (32) which produces a translation of text generated by the OCR object (30), the translation being in a second language different than the first language. Suitably, at least one of the image captured by the scanner (16), the text generated by the OCR object (30), and the translation produced by the language translation object (32) is selectively output on the LCD touch screen (12).

### FIELD

The present inventive subject matter relates to the art of text capturing and language translation. Particular application is found in conjunction with a personal digital assistant (PDA), and the specification makes particular reference thereto. However, it is to be appreciated that aspects of the present inventive subject matter are also amenable to other like applications.

### BACKGROUND

PDAs, as they are known, are electronic computers typically packaged to be hand-held. They are commonly equipped with a limited key pad that facilitates the entry and retrieval of data and information, as well as, controlling operation of the PDA. Most PDAs also include as an input/output (I/O) device a liquid crystal display (LCD) touch screen or the like upon which a graphical user interface (GUI) is supported. PDAs run on various platforms (e.g., Palm OS, Windows CE, etc.) and can optionally be synchronized with and/or programmed through a user's desktop computer. There are many commercially available PDAs produced and sold by various manufactures.

Often, PDAs support software objects and/or programming for time, contact, expense and task management. For example, objects such as an electronic calendar enable a user to enter meetings, appointments and other dates of interest into a resident memory. Additionally, an internal clock/calendar is set to mark the actual time and date. In accordance with the particular protocols of the electronic calendar, the user may selectively set reminders to alert him of approaching or past events. A contact list can be used to maintain and organize personal and business contact information for desired individuals or businesses, i.e., regular mail or post office addresses, phone numbers, e-mail addresses, etc. Business expenses can be tracked with an expense report object or program. Commonly, PDAs are also equipped with task or project management capabilities. For example, with an interactive task management object or software, a so called “to do” list is created, organized, edited and maintained in the resident memory of the PDA. Typically, the aforementioned objects supported by the PDA are interactive with one another and/or linked to form a cohesive organizing and management tool.

The hand-held size of PDAs allows a user to keep their PDA on their person for ready access to the wealth of information and data thereon. In deed, PDAs are effective tools for their designated purpose. However, their full computing capacity is not always effectively utilized.

At times, PDA users (e.g., business professionals, travelers, etc.) desire a language translation of written text, e.g., from Spanish to English or between any two other languages. Often, it is advantageous to obtain the translation in real-time or nearly real-time. For example, a business professional may desire to read a foreign language periodical or newspaper, or a traveler traveling in a foreign country may desire to read a menu printed in a foreign language. Accordingly, in these situations and others like them, users of PDAs would often find it advantageous to utilize the computing capacity of their PDA to perform the translation. Moreover, in view of the limited keypad typically accompanying PDAs, users would also find it advantageous to have a means, other than manual entry, for entering the text to be translated, particularly if the text is lengthy. Heretofore, however, such functionality has not been adequately provided in PDAs.

Accordingly, a new and improved PDA with text scanner and language translation capability is disclosed herein that overcomes the above-referenced problems and others.

### SUMMARY

In accordance with one preferred embodiment, a PDA includes: image acquisition means for capturing an image; text generation means for generating text from the image captured by the image acquisition means, said text being in a first language; and, translation means for producing a translation of the text generated by the text generation means, said translation being in a second language different from the first language.

In accordance with another preferred embodiment, a PDA includes: an LCD touch screen that supports a GUI through which a user selectively provides input to the PDA; a scanner housed within the PDA, the scanner selectively capturing an image by passing the scanner over the image; an OCR object which identifies characters of text within an image captured by the scanner, the OCR object generating text in a first language; and, a language translation object which produces a translation of text generated by the OCR object, the translation being in a second language different than the first language. At least one of the image captured by the scanner, the text generated by the OCR object, and the translation produced by the language translation object is selectively output on the LCD touch screen.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of an exemplary embodiment of a PDA incorporating aspects of the present inventive subject matter.

FIG. 2 is a box diagram showing the interaction and/or communication between various components of the PDA illustrated in FIG. 1.

FIG. 3 is flow chart used to describe an exemplary operation of the PDA illustrated in FIG. 1.

### DETAILED DESCRIPTION OF PREFERRED EMBODIMENTS

For clarity and simplicity, the present specification shall refer to structural and/or functional elements and components that are commonly known in the art without further detailed explanation as to their configuration or operation except to the extent they have been modified or altered in accordance with and/or to accommodate the preferred embodiment(s) presented.

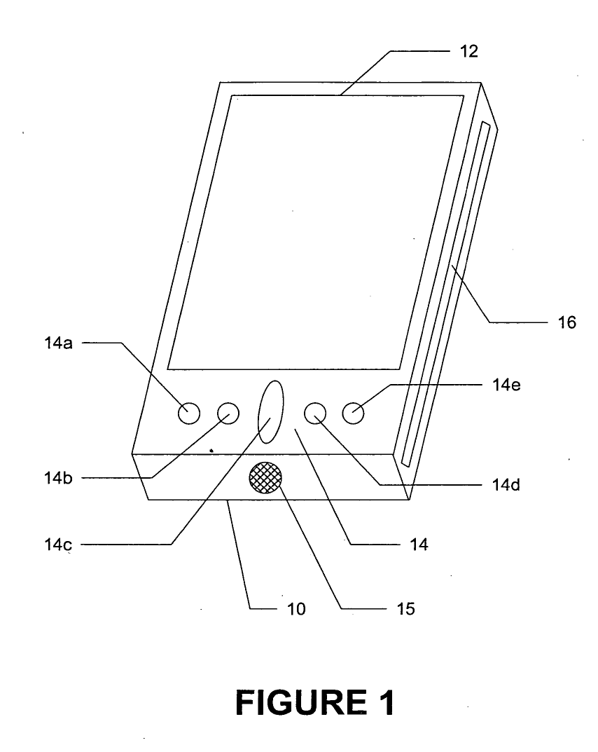

With reference to FIG. 1, a PDA 10 includes in the usual fashion: an LCD touch screen 12 upon which a GUI is supported; a keypad 14 having buttons 14a, 14b, 14c, 14d and 14e; and, a speaker 15 for audible output. While not shown, in addition to or in lieu of the speaker 15, audible output is optionally provided via an audio output jack and ear piece or headphones plugged into the same. As will be more fully appreciated upon further reading of the present specification, in addition to the traditional functions (e.g., calendar, contact list, “to do” list, expense report, etc.) commonly supported on PDAs, the PDA 10 supports the following functions: image capturing, text recognition, language translation, and speech synthesizing.

As illustrated, the PDA 10 also has incorporated therein an optical scanner 16 arranged along the length of one of the PDA's sides. Suitably, the scanner 16 is a hand-held type scanner that is manually moved across a page's surface or other medium bearing an image to be captured. The scanner 16 preferably uses a charge-coupled device (CCD) array, which consist of tightly packed rows of light receptors that detect variations in light intensity and frequency, to observe and digitize the scanned image. The scanner 16 is optionally a color scanner or a black and white scanner, and the raw image data collected is in the form of a bit map or other suitable image format. Additionally, while the scanner 16 has been illustrated as being housed in the PDA 10, optionally, the scanner 16 may be separately housed and communicate with the PDA 10 via a suitable port, e.g., a universal serial bus (USB) port or the like.

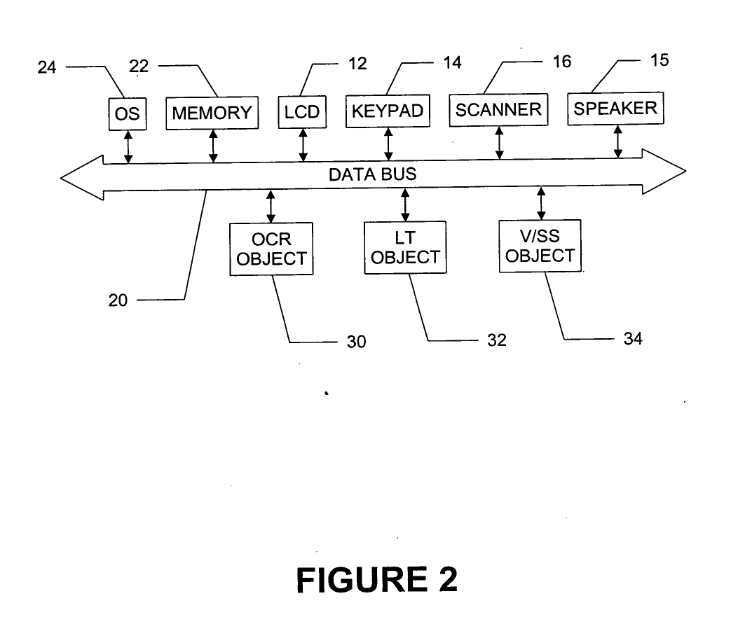

With reference to FIG. 2, the various components of the PDA 10 suitably communicate and/or interact with one another via a data bus 20. The PDA 10 is equipped with a memory 22 that stores data and programming for the PDA 10. Optionally, the memory 22 includes a combination physical memory, RAM, ROM, volatile and non-volatile memory, etc. as is suited to the data and/or programming to be maintained therein. Optionally, other types of data storage devices may also be employed.

An operating system (OS) 24 administers and/or monitors the operation of the PDA 10 and interactions between the various components. User control and/or interaction with the various components (e.g., entering instructions, commands and other input) is provided through the LCD touch screen 12 and keypad 14. Visual output to the user is also provided through the LCD 12, and audile output is provided through the speaker 15.

Suitably, an image captured by the scanner 16 is buffered and/or stored in the memory 22 as image data or an image file (e.g., in bit map format or any other suitable image format). Optionally, depending on the desired function selected by the user, as the image is being captured, it is output to the LCD 12 for real-time or near real-time display of the image.

The PDA 10 is also equipped with an optical character recognition (OCR) object 30, a language translation (LT) object 32 and a voice/speech synthesizer (V/SS) object 34. For example, the forgoing objects are suitably software applications whose programming is stored in the memory 22.

The OCR object 30 accesses image data and/or files from the memory 22 and identifies text characters therein. Based on the identified characters, the OCR object 30 generates a text-based output or file (e.g., in ASCII format or any other suitable text-based format) that is in turn buffered and/or stored in the memory 22. Optionally, depending on the desired function selected by the user, as the image is being captured by the scanner 16, it is provided to and/or accessed by the OCR object 30 in real-time or near real-time. Accordingly, in addition to or in lieu of storing the text-base output in the memory 22 for later access and/or use, the OCR object 30 in turn optionally provides its text-based output to one or more of: the LCD 12 for real-time or near real-time display of the text-based output; the LT object 32 for translation in real-time or near real-time; and, the V/SS object 34 for real-time or near real-time reading of the scanned text.

The LT object 32 accesses text data and/or files from the memory 22 and translates it into another language. Suitably, the LT object 32 is equipped to translate between any number of different input and output languages. For example, both the input language and out language may be selected or otherwise designated by the user. Alternately, the input language is determined by the LT object 32 based upon a sampling of the input text, and the output language is some default language, e.g., the user's native language.

Suitably, the accessed text is parsed and translated sentence by sentence. Notably, breaking down each sentence into component parts of speech permits analysis of the form, function and syntactical relationship of each part, thereby providing for an accurate translation of the sentence as a whole as opposed to a simple translation of the words in that sentence. However, a single word by word translation is an option.

The translated text is in turn buffered and/or stored in the memory 22. Optionally, depending on the desired function selected by the user, as the text-based output is being generated by the OCR object 30, it is provided to and/or accessed by the LT object 32 in real-time or near real-time. Accordingly, in addition to or in lieu of storing the translated text in the memory 22 for later access and/or use, the LT object 32 in turn optionally provides the translated text to one or more of: the LCD 12 for real-time or near real-time display of the translation; and, the V/SS object 34 for real-time or near real-time reading of the translation.

The V/SS object 34 accesses text data and/or files from the memory 22 (either pre- or post-translation, depending upon the function selected by the user) and reads the text, i.e., converts it into corresponding speech. Suitably, the speech is buffered and/or stored in the memory 22 as audio data or an audio file (e.g., in MP3 or any other suitable audio file format). Optionally, depending on the desired function selected by the user, as the text is being generated by the OCR object 30 or the translated text is being output by the LT object 32, it is provided to and/or accessed by the V/SS object 34 in real-time or near real-time. Accordingly, in addition to or in lieu of storing the audio data in the memory 22 for later access and/or use, the V/SS object 34 optionally provides the audio data to achieve real-time or near real-time audible reading of the scanned text or translation, as the case may be, output via the speaker 15.

Suitably, the V/SS object 34 is capable of generating speech in a plurality of different languages so as to match the language of the input text. Optionally, the language for the generated speech is determined by the V/SS object 34 by sampling the input text. Alternately, the V/SS object 34 speaks a default language, e.g., corresponding to the native language of the user.

As can be appreciated, from the view point of acquisition, the PDA 10 operates in either a storage mode, a real-time mode or a combined storage/real-time mode. Suitably, the mode is selected by the user at the start of a particular acquisition operation. In the storage mode, one or more of the outputs (i.e., those of interest) from the scanner 16, the OCR object 30, the LT object 32 and/or the V/SS object 32 are stored in the memory 22, e.g., for later access and/or use in a playback or display operation. In the real-time mode, one or more of the outputs (i.e., those of interest) from the scanner 16, the OCR object 30, the LT object 32 and/or the V/SS object 32 are directed to the LCD 12 and/or speaker 15, as the case may be, for real-time or near real-time viewing and/or listening by the user. In the combined mode, as the name suggests, selected outputs are both stored in the memory 22 and directed to the LCD 12 and speaker 15.

Additionally, for each acquisition operation, there are a number of potential outputs the user has to select from. In a mere image acquisition operation, the output of the scanner 16 is of interest and processed according to the mode selected. In a text acquisition operation, the output of the OCR object 30 is of interest and processed according to the mode selected. In a translation acquisition, the output of the LT object 32 is of interest and processed according to the mode selected. Of course, the user may select a plurality of the outputs if they should be interested in such, and each output processed according to the mode selected for that output.

Finally, the user is able to select from visual or audible delivery of the outputs. If the visual delivery selection is chosen by the user, the output from the scanner 16, the OCR object 30 or the LT object 32 is directed to the LCD 12, depending on the type of acquisition operation selected. If the audible review selection is chosen by the user, the output from the V/SS object 34 is directed to the speaker 15. Note, audible delivery is compatible with the text acquisition operation (in which case the V/SS object 34 uses as input the output from the OCR object 30) and the translation acquisition operation (in which case the V/SS object 34 uses as input the output from the LT object 32); audible delivery is, however, incompatible with an image acquisition operation. Of course, in the case of the text and translation acquisition operations, the user may select both visual and audible delivery. Moreover, the user may select that the scanned text be displayed while the translation is read, or vise versa.

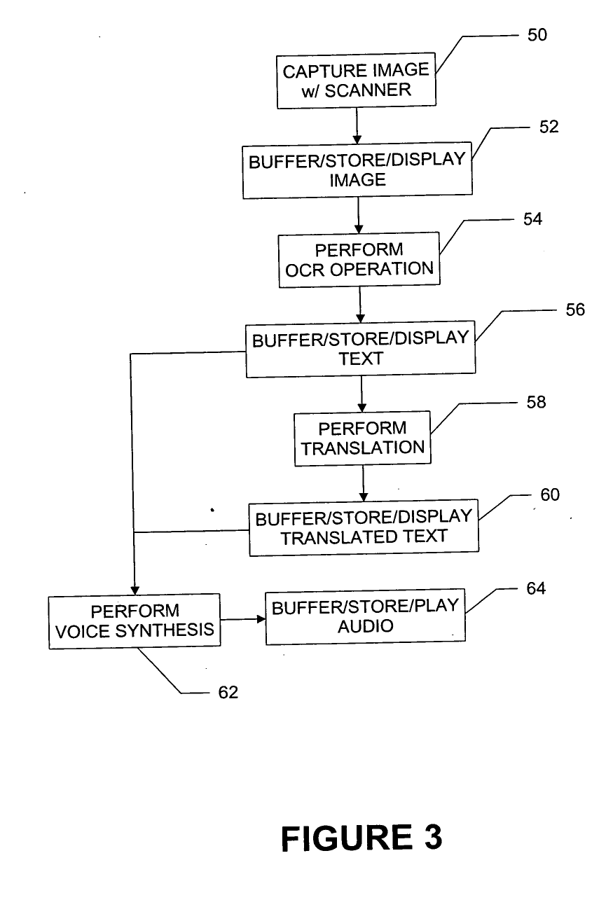

With reference to FIG. 3, an exemplary acquisition operation is broken down in to a plurality of steps. The operation begins at first step 50 wherein an image is captured with the scanner 16. Notably, as an alternative to the scanner 16, a digital camera or other like image capturing device may be used. In any event, at step 52, the captured image is buffered/stored in the memory 22 and/or displayed on the LCD 12, depending on the mode selected and the type of acquisition selected and the delivery preference selected.

At step 54, an OCR operation is performed by the OCR object 30 with the captured image serving as the input. The OCR operation generates as output data and/or a file in a text-based format. At step 56, the generated text is buffered/stored in the memory 22 and/or displayed on the LCD 12, depending on the mode selected and the type of acquisition selected and the delivery preference selected.

At step 58, a language translation operation is performed by the LT object 32 with the generated text serving as the input. The language translation operation produces as output a translation of the input in a text-based format. At step 60, the translation produced is buffered/stored in the memory 22 and/or displayed on the LCD 12, depending on the mode selected and the type of acquisition selected and the delivery preference selected.

Optionally, in the case where the user has selected audible delivery of either the text generated by the OCR object 30 or the translation produced by the LT object 32, at step 62, a voice/speech synthesis operation is performed by the V/SS object 34 with the respective text or translation serving as the input. The voice/speech synthesis produces as output audio data representative of or an audio file containing speech corresponding to the input text. At step 64, the audio data or file is buffered/stored in the memory 22 and/or played via the speaker 15, depending on the mode selected and the type of acquisition selected.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

1. A personal digital assistant (PDA) comprising:
image acquisition means for capturing an image;
text generation means for generating text from the image captured by the image acquisition means, said text being in a first language; and,
translation means for producing a translation of the text generated by the text generation means, said translation being in a second language different from the first language.

2. The PDA of claim 1, further comprising:
audiblization means for producing speech from at least one of the text generated by the text generation means and the translation produced by the translation means.

3. The PDA of claim 1, further comprising:
visualization means for displaying at least one of the image captured by the image acquisition means, the text generated by the text generation means and the translation produced by the translation means.

4. The PDA of claim 1, wherein the image acquisition means includes a scanner that passed across the image to capture it.

5. The PDA of claim 4, wherein the scanner is housed within the PDA.

6. The PDA of claim 1, wherein the image acquisition means includes a digital camera.

7. The PDA of claim 1, wherein the text generation means includes an optical character recognition (OCR) object that identifies text characters in the image captured by the image acquisition means.

8. The PDA of claim 1, wherein the translation means includes a language translation object that translates text from the first language to the second language.

9. The PDA of claim 8, wherein the language translation object parses and translates text an entire sentence at a time.

10. The PDA of claim 2, wherein the audiblization means includes a speech synthesizer that generates audio data representative of speech that corresponds to text input into the speech synthesizer.

11. The PDA of claim 10, further comprising:
audio output means for outputting audible speech from the speech synthesizer.

12. The PDA of claim 3, wherein the visualization means includes a liquid crystal display (LCD).

13. The PDA of claim 12, wherein the LCD is an LCD touch screen that supports a graphical user interface (GUI) through which a user selectively provides input to the PDA.

14. A personal digital assistant (PDA) comprising:
a liquid crystal display (LCD) touch screen that supports a graphical user interface (GUI) through which a user selectively provides input to the PDA;
a scanner housed within the PDA, said scanner selectively capturing an image by passing the scanner over the image;
an optical character recognition (OCR) object which identifies characters of text within an image captured by the scanner, said OCR object generating text in a first language; and,
a language translation object which produces a translation of text generated by the OCR object, said translation being in a second language different than the first language;
wherein at least one of the image captured by the scanner, the text generated by the OCR object, and the translation produced by the language translation object is selectively output on the LCD touch screen.

15. The PDA of claim 14, further comprising:
a speech synthesizer produces speech from at least one of the text generated by the OCR object and the translation produced by the language translation object; and,
an audio output from which the speech is audibly played.

16. The PDA of claim 15, wherein the at least one of the speech from the speech synthesizer, the translation from the language translation object, and text from the OCR object is generated in substantially real-time relative to the capturing of the image with the scanner.

17. The PDA of claim 15, further comprising:
a memory in which is stored at least one of the speech from the speech synthesizer, the translation from the language translation object, and text from the OCR object.
